(19) United States
(12) Patent Application Publication
(10) Pub. No.: US 2025/0154814 A1
(43) Pub. Date: May 15, 2025

(54) DOOR ABSOLUTE POSITION BASED ON ACCELEROMETER FOR POWERED CLOSURE MEMBER ACTUATION SYSTEM

(71) Applicant: MAGNA CLOSURES INC., Newmarket (CA)

(72) Inventor: Antonio FRELLO, Newmarket (CA)

(21) Appl. No.: 18/937,988

(22) Filed: Nov. 5, 2024

Related U.S. Application Data
(60) Provisional application No. 63/548,015, filed on Nov. 10, 2023.

(51) Int. Cl. E05F 15/40; E05B 81/56; E05B 81/70; E05F 15/77

(52) U.S. Cl. CPC E05F 15/40; E05B 81/56; E05B 81/70; E05F 15/77; E05Y 2400/32; E05Y 2400/40; E05Y 2400/446; E05Y 2900/531

(57) ABSTRACT

A power closure member actuation system for a vehicle having a plurality of doors and corresponding method of operation are provided. The system includes at least one power actuator associated with and configured to move one of the plurality of doors. The system also includes an inclination sensor configured to detect an initial inclination of the one of the plurality of doors at a predetermined position of one of the plurality of doors and a current inclination of the one of the plurality of doors at a current position of one of the plurality of doors. The at least one power actuator is operated based on the current position of the one of the plurality of doors determined using the initial inclination detected at the predetermined position and the current inclination detected at the current position.

### CROSS-REFERENCE TO RELATED APPLICATION

This application claims the benefit of U.S. Provisional Application No. 63/548,015 filed Nov. 10, 2023, the entire disclosure of which is incorporated herein by reference.

### FIELD

The present disclosure relates generally to closure systems for closure members of motor vehicles and, more particularly, to a power closure member actuation or door control system for opening and closing doors of the motor vehicle automatically.

### BACKGROUND

This section provides background information related to the present disclosure which is not necessarily prior art.

A typical motor vehicle is equipped with at least one pair of doors to provide access to a passenger compartment. Specifically, most vehicles include driver-side and passenger-side swing doors that are pivotably supported from the vehicle body to move between closed and open positions. These doors are each equipped with a latch assembly having a latch mechanism operable in a latched mode to hold the door in its closed position and in an unlatched mode to permit movement of the door to its open position. The latch assembly is also equipped with a latch release mechanism that is selectively actuated (manually via a handle-actuated release system and/or via a power-operated release system) to shift the latch mechanism into its unlatched mode.

Many vehicles are equipped with multiple side (i.e., front and rear) doors for access to the passenger compartment. Most commonly, when viewed from the front of the vehicle 10, the front and rear side doors 12, 14 are hinged proximate their front edge to be moveable relative to a vehicle body 15 as best shown in FIG. 1. The front doors 12 are hinged to a front structural pillar (i.e., the A-pillar 16), while the rear doors 14 are hinged to an intermediate structural pillar (i.e., the B-pillar 18), which is situated between the front and rear doors 12, 14. The latch assemblies 20 associated with the front doors 12 are arranged to latch with a front striker (not shown) fixed to the B-pillar 18. Likewise, the latch assemblies 22 associated with the rear doors 14 are arranged to latch with a rear striker 24 fixed to a rearward, vertically extending shut face 25 of the opening 26.

As a further advancement, power door or power closure member actuation systems have been developed. For passenger doors, like those described above, the power closure member actuation or power closure system can function to automatically swing the doors about their pivot axes between the open and closed positions, to assist the user as he or she moves the door, and/or to pop out or present the door to the user. Typically, power closure systems include a power-operated device such as, for example, an electric motor and a rotary-to-linear conversion device that are operable for converting the rotary output of the electric motor into translational movement of an extensible member. In many arrangements, the electric motor and the conversion device are mounted to the door and the distal end of the extensible member is fixedly secured to the vehicle body. One example of a power closure system for a passenger door is shown in commonly-owned International Publication No. WO2013/013313 to Schuering et al. which discloses use of a rotary-to-linear conversion device or power actuator having an externally-threaded leadscrew rotatively driven by the electric motor and an internally-threaded drive nut meshingly engaged with the leadscrew and to which the extensible member is attached. Accordingly, control over the speed and direction of rotation of the leadscrew results in control over the speed and direction of translational movement of the drive nut and the extensible member for controlling swinging movement of the passenger door between its open and closed positions. Nevertheless, difficulties are typically encountered when controlling movement of the doors including sensing accurate absolute position of the doors.

In view of the above, there remains a need to develop alternative power closure member actuation systems which address and overcome limitations and drawbacks associated with known systems, as well as to provide increased convenience and enhanced operational capabilities.

### SUMMARY

This section provides a general summary of the present disclosure and is not a comprehensive disclosure of its full scope or all of its features, aspects and objectives.

It is an aspect of the present disclosure to provide a power closure member actuation system for a vehicle having a plurality of doors. The system includes at least one power actuator associated with and configured to move one of the plurality of doors. The system also includes an inclination sensor configured to detect an initial inclination of the one of the plurality of doors at a predetermined position of one of the plurality of doors and a current inclination of the one of the plurality of doors at a current position of one of the plurality of doors. The at least one power actuator is operated based on a position of the one of the plurality of doors determined using the initial inclination detected at the predetermined position and the current inclination detected at the current position.

Another aspect of the present disclosure relates to a method of operating power closure member actuation system for a vehicle having a plurality of doors. The method includes the step of detecting an initial inclination of one of the plurality of doors at a predetermined position of the one of the plurality of doors and a current inclination of the one of the plurality of doors at a current position of the one of the plurality of doors using an inclination sensor. The method also includes the step of moving the one of the plurality of doors using at least one power actuator associated therewith, the at least one power actuator operated based on the current position of the one of the plurality of doors determined using the initial inclination detected at the predetermined position and the current inclination detected at the current position.

Yet another aspect of the present disclosure relates to a method of operating a power closure member actuation system. The method includes the step of reading and storing an initial inclination of the one of the plurality of doors at a closed position of one of the plurality of doors in a memory device of at least one controller. The method continues with the step of receiving a door open command for the one of the plurality of doors. The method proceeds by unlatching a latch assembly of the one of the plurality of doors. The next step of the method is moving the one of the plurality of doors to an open position using a power actuator operably coupled to the one of the plurality of doors while monitoring a position of the one of the plurality of doors during motion using one of a plurality of position sensors. Next, determining an inclination value of the one of the plurality of doors based on the initial inclination of the one of the plurality of doors and the position of the one of the plurality of doors from the one of a plurality of position sensors. In addition, the method includes the step of at an open position of the one of the plurality of doors, disabling the power actuator. The method continues with the step of losing the position of the one of the plurality of doors from the one of a plurality of position sensors. The method proceeds by reading a current inclination of the one of the plurality of doors at a current position of one of the plurality of doors. The method also includes the step of determining the current position of the one of the plurality of doors using the initial inclination detected at the closed position and the current inclination detected at the current position.

Yet another aspect includes a power closure member actuation system for a vehicle having a door moveable between and open position and a closed position, having a power actuator associated with and configured to move the door using a position value of the door, and an inclination sensor configured to detect an inclination of the door, where the position value is updated using the inclination sensor following a loss in tracking of the door position of the power closure member actuation system.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a motor vehicle equipped with separate latch assemblies for each door in accordance with the prior art;

FIG. 2 shows another motor vehicle equipped with separate latch assemblies and power actuators for each door that are operated by a passive entry feature used in conjunction with an electronic key fob, according to aspects of the disclosure;

FIG. 3 is a block diagram of an example power closure member actuation system, according to aspects of the disclosure;

FIG. 4 illustrates the power closure member actuation system shown as part of vehicle system architectures according to aspects of the disclosure; and

FIG. 5 illustrates steps of a method of operating a power closure member actuation system, according to aspects of the disclosure.

### DETAILED DESCRIPTION

In the following description, details are set forth to provide an understanding of the present disclosure. In some instances, certain circuits, structures and techniques have not been described or shown in detail in order not to obscure the disclosure.

In general, at least one example embodiment of a power closure member actuation system and corresponding method of operation constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are described in detail.

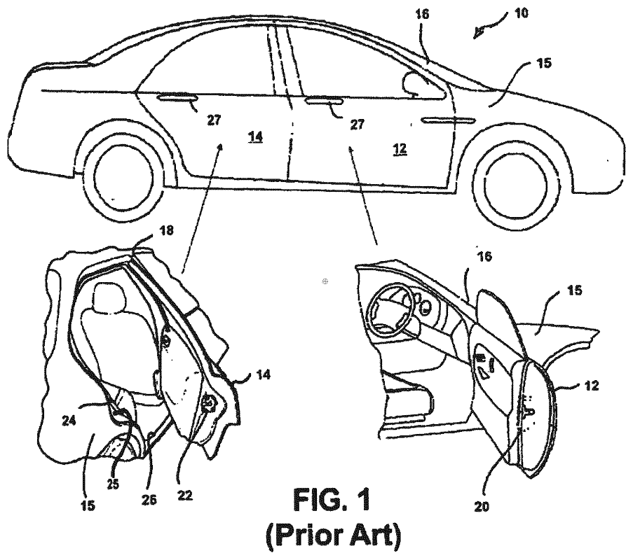

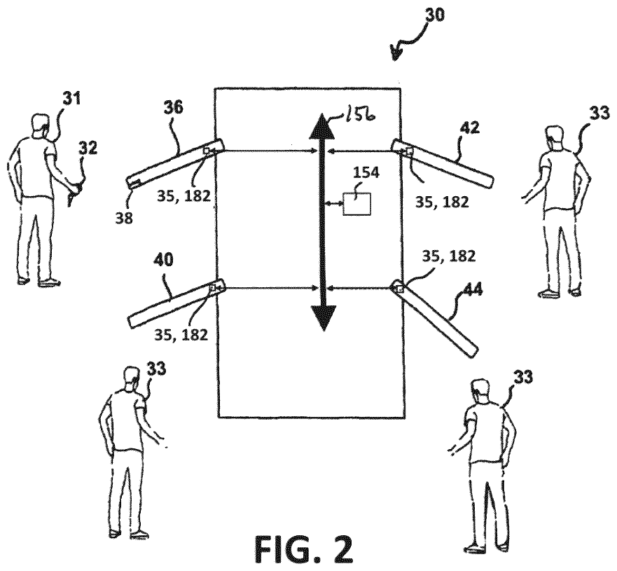

Referring to FIG. 2, for a vehicle 30 with a passive entry feature, a person 31 may approach the vehicle 30 and actuate (i.e. pull) an outside door handle 27 (FIG. 1) or electronically command unlatching and opening with an electronic key fob 32. For example, a single closure member opening command from the key fob 32 can be used for unlatching a driver's side front door 36 (i.e., the driver's door) and/or control a power actuator 35 configured to move the driver's side front door 36 between an open position and a closed position. Consequently, a latch assembly 38 associated with the driver's side front door 36 actuates the power release function to release a latch mechanism of the latch assembly 38 and unlatch for opening the driver's side front door 36 using the power actuator 35. A second or subsequent command from the key fob 32 can be used for unlatching the remaining doors for passengers 33 (e.g., driver's side rear door 40, passenger's side front door 42 opposite the driver's side front door 36, and passenger's side rear door 44 opposite the driver's side rear door 40) and controlling power actuators 35 configured to move the driver's side rear door 40, passenger's side front door 42, and passenger's side rear door 44 between open and closed positions, as shown. Accordingly, all of the doors 36, 40, 42, 44 may be unlocked and commanded open by the second closure member opening command from the key fob 32, even if the person 31 only wants to unlock the driver's side rear door 40. Similarly, the doors 36, 40, 42, 44 may also be automatically closed using the power actuators 35. However, the doors 36, 40, 42, 44 may move at different speeds and/or stop motion (e.g., at the open position or closed position) at different times.

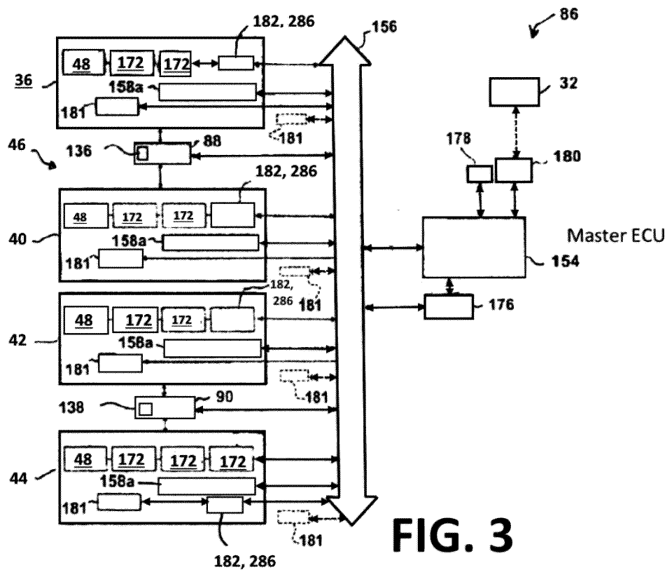

Thus, according to an aspect, and referring to FIG. 3, a power closure system or door control system 86 for a vehicle 10, 30 is shown. The power closure system 86 includes a plurality of doors 36, 40, 42, 44 each driven by one of the plurality of power actuators 35. At least one controller 154, 182 is adapted to control each of the plurality of power actuators 35 to move each of the plurality of doors 36, 40, 42, 44 at a target speed. The power closure system 86 also includes a sensor system 46 for monitoring an actual speed of each of the plurality of doors 36, 40, 42, 44. The at least one controller 154, 182 is configured to monitor the actual speed of each of the plurality of doors 36, 40, 42, 44 using the sensor system 46.

Still referring to FIG. 3, in the example power closure system 86, each of the driver's side front door 36, the driver's side rear door 40, the passenger's side front door 42, and the passenger's side rear door 44, can also include one or more of a plurality of obstacle detection sensors 172. The plurality of obstacle detection sensors 172 are configured to detect an object or a gesture adjacent the driver's side front door 36 and the driver's side rear door 40 and the passenger's side front door 42 and the passenger's side rear door 44. According to an aspect, the at least one controller 154, 182 includes a plurality of door control units 182 (PSD ECU) each disposed in one of the plurality of doors 36, 40, 42, 44 and configured to control the actual speed of each of the plurality of doors 36, 40, 42, 44. According to another aspect, the sensor system 46 includes a plurality of position sensors 48 (PSD Position Sensor, e.g., Hall effect sensor) each disposed on one of the doors 36, 40, 42, 44 and configured to detect a position and the actual speed of the one of the doors 36, 40, 42, 44 associated therewith. The actual speed may be computed by a change in the position measured per unit time. So, the doors 36, 40, 42, 44 each include one of a plurality of door control units 182 coupled one or more of the plurality of obstacle detection sensors 172 and one of the plurality of position sensors 48. The door control units 182 in each door 36, 40, 42, 44 communicate over a bus 156 with a master electronic control unit 154 (e.g., Body Control Module 154) powered by a power source 176. The master electronic control unit 154 is additionally connected to a liquid crystal display (LCD) 178 and communicates with the key fob 32 via a wireless interface 180. Each door 36, 40, 42, 44 also includes a motor 181 included with each of the power actuators 35 used for powered movement of the door 36, 40, 42, 44 and controlled by one of the door control units 182.

According to an aspect, the power closure system 86 includes latch assemblies 88, 90, one on each side of the motor vehicle 10, 30. A first side of the vehicle 10, 30 can includes a first side latch assembly 88 for independently latching and unlatching the driver's side front door 36 and the driver's side rear door 40. A second side latch assembly 90 independently latches the passenger's side front door 42 and the passenger's side rear door 44. Each of the latch assemblies 88, 90 respectively includes a controller unit 136, 138 configured to receive at least one closure member opening command from an input source selected from an actuation mechanism, also referred to as input source, such as from a group comprising a handle switch 158 a (e.g., actuated in response to actuation of outside door handle 27 (FIG. 1)), master electronic control unit 154, or the key fob 32. In more detail, only the controller unit 136, 138 that is on the same side of the vehicle 10, 30 as the person 31 with the key fob 32 (or the side in which the person 31 pulls the outside door handle 27 of the door 36, 40, 42, 44 to activate the handle switch 158a) is configured to act on the at least one closure member opening command from the input source. Additional details regarding such a dual pillar-less door or closure system 86 can be found in United States Publication No. 2023/0016866 A1 entitled “Dual function latch assembly for dual door pillar-less door system and control system for controlling the latch assembly”, the entire contents of which are incorporated herein by reference in its entirety. Nevertheless, it should be appreciated that instead of the power closure system or door control system 86 only including one latch assembly 88, 90 per side of the vehicle 10, 30, the door control system 86, could instead have latch assemblies for each door 36, 40, 42, 44 controlled individually by respective door control units 182 in each door 36, 40, 42, 44.

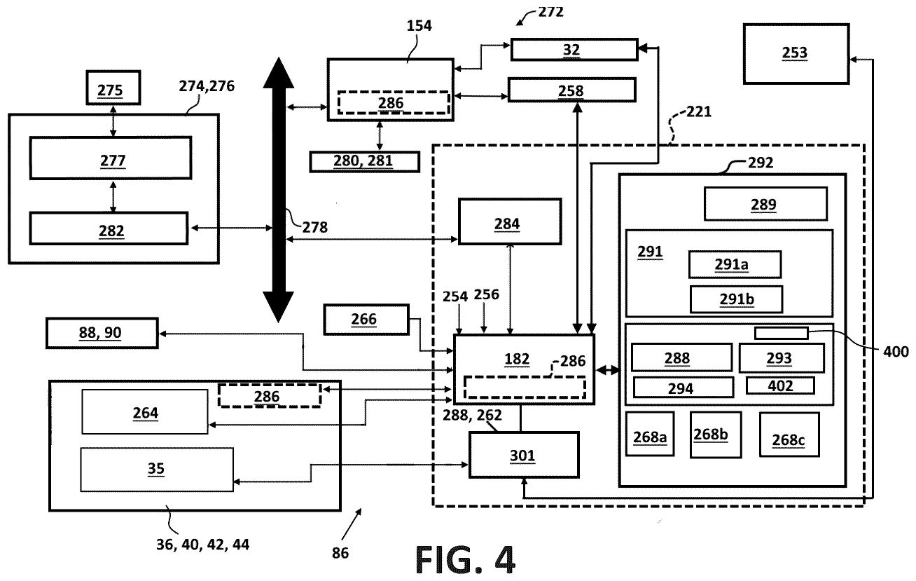

In FIG. 4, a door control system 221 of the power closure member actuation system 86 is shown as part of a vehicle system architecture 272 corresponding to operation in an automatic mode. The power closure member actuation system 86 includes a user interface 274, 276 that is configured to detect a user interface input from a user 275 (e.g., person 31 or passenger 33) via an interface 277 (e.g., touchscreen) to modify at least one stored motion control parameter associated with the movement of the closure member (e.g., door 36, 40, 42, 44). Thus, the at least one controller 154, 182 of the power closure member actuation system 86 or user modifiable system is configured to present the at least one stored motion control parameter on the user interface 274, 276.

The at least one controller 154, 182 is configured to receive an automatic mode initiation input 254 and enter the automatic mode to output a motion command 262 in response to receiving the automatic mode initiation input 254 or an input motion command 262. The automatic mode initiation input 254 can be a manual input on the closure member itself or an indirect input to the vehicle 10, 30 (e.g., closure member switch 258 on the door 36, 40, 42, 44, switch on a key fob 32, etc.). So, the automatic mode initiation input 254 may, for example, be a result of a user or operator 275 operating a switch (e.g., the closure member switch 258), making a gesture near the vehicle 10, 30, or possessing the key fob 32 near the vehicle 10, 30, for example. It should also be appreciated that other automatic mode initiation inputs 254 are contemplated, such as, but not limited to a proximity of the user 275 detected by a proximity sensor.

In addition, the power closure member actuation system 86 includes at least one closure member feedback sensor 264 for determining at least one of a position and a speed and an attitude of the closure member or door 36, 40, 42, 44. Thus, the at least one closure member feedback sensor 264 detects signals from either the power actuator 35 by counting revolutions of an electric motor of the power actuator 35, absolute position of an extensible member (not shown), or from the door 36, 40, 42, 44 (e.g., an absolute position sensor on a door check as an example) can provide position information to the at least one controller 154, 182. Feedback sensor 264 is in communication with the at least one controller 154, 182 and is illustrative of part of a feedback system or motion sensing system for detecting motion of the door 36, 40, 42, 44 directly or indirectly, such as by detecting changes in speed and position of the door 36, 40, 42, 44, or components coupled thereto. For example, the motion sensing system may be hardware based (e.g. a hall sensor unit an related circuitry) for detecting movement of a target on the closure member (e.g. on the hinge) or actuator 35 (e.g. on a motor shaft) as examples, and/or may also be software based (e.g. using code and logic for executing a ripple counting algorithm) executed by the at least one controller 154, 182 for example.

The body control module 154 is in communication with the at least one controller 154, 182 via a vehicle bus 278 (e.g., a Local Interconnect Network or LIN bus). The body control module 154 can also be in communication with the key fob 32 (e.g., wirelessly) and a closure member switch 258 configured to output a closure member trigger signal through the body control module 154. Alternatively, the closure member switch 258 could be connected directly to the at least one controller 154, 182 or otherwise communicated to the at least one controller 154, 182. The body control module 154 may also be in communication with an environmental sensor (e.g., temperature sensor 280). The at least one controller 154, 182 is also configured to modify the at least one stored motion control parameter in response to detecting the user interface input. A screen communications interface control unit 282 associated with the user interface 274, 276 can, for example, communicate with a closure communications interface control unit 84 associated with the at least one controller 154, 182 via the vehicle bus 278. In other words, the closure communication interface control unit 284 is coupled to the vehicle bus 278 and to the at least one controller 154, 182 to facilitate communication between the at least one controller 154, 182 and the vehicle bus 278. Thus, the user interface input can be communicated from the user interface 274, 276 to the at least one controller 154, 182.

A vehicle inclination sensor 286 (such as an accelerometer) is also coupled to the at least one controller 154, 182 for detecting an inclination of the vehicle 10, 30. The vehicle inclination sensor 286 outputs an inclination signal corresponding to the inclination of the vehicle 10, 30 and the at least one controller 154, 182 is further configured to receive the inclination signal and adjust the one of a force command 288 and the motion command 262 accordingly. While the vehicle inclination sensor 286 may be separate from the at least one controller 154, 182, it should be understood that the vehicle inclination sensor 286 may also be integrated in the at least one controller 154, 182 or in another control module, such as, but not limited to the body control module 154.

The at least one controller 154, 182 is further configured to perform at least one of an initial boundary condition check prior to the generation of the command signal (e.g., the force command 288 or the motion command 262) and an in-process boundary check during the generation of the command signal. Such boundary checks prevent movement of the closure member and operation of the power actuator 35 outside a plurality of predetermined operating limits or boundary conditions 291 and will be discussed in more detail below.

The power closure member actuation system 86 additionally includes at least one non-contact obstacle detection sensor 266 which may form part of a non-contact obstacle detection system coupled, such as electrically coupled, to the at least one controller 154, 182. The at least one controller 154, 182 is configured to determine whether an obstacle is detected using the at least one non-contact obstacle detection sensor 266 and may, for example, cease movement of the doors 36, 40, 42, 44 in response to determining that the obstacle is detected.

The at least one controller 154, 182 can also be coupled to the latch assemblies 88, 90. In addition, the at least one controller 154, 182 is coupled to a memory device 292 having at least one memory location for storing at least one stored motion control parameter associated with controlling the movement of the closure member (e.g., one of the plurality of doors 36, 40, 42, 44). The memory device 292 can also store one or more closure member motion profiles 268 (e.g., movement profile A 268 a, movement profile B, 268 b, movement profile C 268 c) and boundary conditions 291 (e.g., the plurality of predetermined operating limits such as minimum limits 291 a, and maximum limits 291 b). The memory device 292 also stores original equipment manufacturer (OEM) modifiable door motion parameters 289 (e.g., door check profiles and pop-out profiles).

The at least one controller 154, 182 is configured to generate the motion command 262 using the at least one stored motion control parameter to control an actuator output force acting on the closure member to move the closure member. A pulse width modulation unit 301 is coupled to the at least one controller 154, 182 and is configured to receive a pulse width control signal and output an actuator command signal corresponding to the pulse width control signal. The pulse width modulation unit 301 is also connected to a vehicle battery 253.

The body control module 154 may also be in communication with at least one environmental sensor 280, 281 for sensing at least one environmental condition 259. Specifically, the at least one environmental sensor 280, 281 can be at least one of a temperature sensor 280 or a rain sensor 281. While the temperature sensor 280 and rain sensor 281 may be connected to the body control module 154, they may alternatively be integrated in the body control module 154 and/or integrated in another unit such as, but not limited to the at least one controller 154, 182. In addition, other environmental sensors 280, 281 are contemplated.

Again, the vehicle inclination sensor 286 (such as an accelerometer or inclinometer) is also coupled to the at least one controller 154, 182 for detecting the inclination of the vehicle 10, 30. The vehicle inclination sensor 286 outputs an inclination signal corresponding to the inclination of the vehicle 10, 30 and the at least one controller 154, 182 is further configured to receive the inclination signal and adjust the one of the force command 288 and the motion command 262 accordingly. Accordingly may be for example adjusting the motion command 262 such that one of the plurality of doors 36, 40, 42, 44 moves at the same speed and motion profile as compared to the one of the plurality of doors 36, 40, 42, 44 being moved by a motion command as if on a level terrain. As a result, the power actuator 35 may move the one of the plurality of doors 36, 40, 42, 44 such that the motion profile (e.g. speed versus door position) when on an incline is the same as or is tracking to the motion profile as if the vehicle was not on an incline. In other words the user detects no visual difference in the door motion appearance of speed versus position as when the vehicle 10, 30 is on an incline or not. Or for example accordingly may be adjusting the force command 88 such that one of the plurality of doors 36, 40, 42, 44 is moved applying the similar resistance force detected by a user as compared to the door being moved by a force command as if on level terrain. As a result, the power actuator 35 may move the door such that the force required to move the one of the plurality of doors 36, 40, 42, 44 by a user when on an incline is the same as the force required by a user to move the door as if the vehicle was not on an incline. In other words, the user experiences the same reactionary resistive force of the door 36, 40, 42, 44 acting against the input force of the user 275 when the vehicle 10, 30 is on an incline or not.

The pulse width modulation unit 301 is also coupled to the at least one controller 154, 182 and is configured to receive a pulse width control signal and output an actuator command signal corresponding to the pulse width control signal. The at least one controller 154, 182 is coupled to the memory device 292 for storing a plurality of automatic closure member motion parameters 268, 293, 294 for the automatic mode and a plurality of powered closure member motion parameters for the powered assist mode and used by the at least one controller 154, 182 for controlling the movement of the closure member (e.g., one of the plurality of doors 36, 40, 42, 44). Specifically, the plurality of automatic closure member motion parameters 268, 293, 294 includes at least one closure member motion profile 268 (e.g., plurality of closure member velocity and acceleration profiles), a plurality of closure member stop positions 293, and a closure member check sensitivity 294. The plurality of powered closure member motion parameters includes at least one of a plurality of fixed closure member model parameters and a force command generator algorithm and a closure member model and a plurality of closure member component profiles. In addition, the memory device 292 stores a date and mileage and cycle count. The memory device 292 may also store boundary conditions (e.g., plurality of predetermined operating limits) used for a boundary check to prevent movement of the closure member and operation of the power actuator 35 outside a plurality of predetermined operating limits or boundary conditions.

Consequently, the at least one controller 154, 182 is configured to receive one of the motion input 256 associated with the powered assist mode and the automatic mode initiation input 254 associated with the automatic mode. The at least one controller 154, 182 is then configured to send the power actuator 35 one of a motion command 262 based on the plurality of automatic closure member motion parameters 268, 293, 294 in the automatic mode and the force command 88 based on the plurality of powered closure member motion parameters in the powered assist mode to vary the actuator output force acting on the one of the plurality of doors 36, 40, 42, 44 to move the closure member or one of the plurality of doors 36, 40, 42, 44. The at least one controller 154, 182 additionally monitors and analyzes historical operation of the power closure member actuation system 86 and adjusts the plurality of automatic closure member motion parameters 268, 293, 294 and the plurality of powered closure member motion parameters accordingly.

As discussed above, the power closure member actuation system 86 can include the environmental sensor 280, 281 in communication with the at least one controller 154, 182 and configured to sense at least one environmental condition of the vehicle 10, 30. Thus, the historical operation monitored and analyzed by the at least one controller 154, 182 includes the at least one environmental condition of the vehicle 10, 30. So, the at least one controller 154, 182 is further configured to adjust the plurality of automatic closure member motion parameters 268, 293, 294 and the plurality of powered closure member motion parameters based on the at least one environmental condition of the vehicle 10, 30.

It has been discovered that some closure systems may lose position information for the plurality of doors 36, 40, 42, 44 when one or more of the doors 36, 40, 42, 44 is in an open position when in a low power mode or due to disconnection of the vehicle battery 253, or due to a reboot, or reinitialization of the computer or control system, or an erasure of the memory tracking the current door position, as but non-limiting examples, causing to a loss of tracking of the door position. For example, a non-absolute sensor in a power side door actuator having a hall sensor may send rotation position counts to controller 154, 182 as the door is moving away from closed position e.g. a reference position, which the controller 154, 182 can convert into a door angle or door position. If for example power is lost at door angle of 35 degrees and the door is continued to be moved to 40 degrees under manual guidance of a human user, when power is restored. the last stored door angle in memory is 35 degrees whereas the actual door position angle is 40 degrees, and thus there is a discrepancy between the door position in memory and the actual physical door position. Therefore, when the at least one controller 154, 182 wakes up, the power door algorithm may be disabled due to the position being unknown (so any force compensation model is not reliable and/or any pinch detection cannot be guaranteed). As discussed and still referring to FIG. 4, the power closure member actuation system 86 can include the accelerometer or inclination sensor 286. The accelerometer or inclination sensor 286 may be located or secured directly on the door 36, 40, 42, 44, and may for example be located as part of a Door Control Module (DCM), or as part of an electronic latch (Elatch), each having a printed circuit board and other types of electronics for control of a motor or other sensors. Other locations and supporting structures are also possible. Thus, according to an aspect, the inclination sensor 286 is configured to detect an initial inclination of the one of the plurality of doors 36, 40, 42, 44 at a predetermined position of one of the plurality of doors 36, 40, 42, 44 and a current inclination of the one of the plurality of doors 36, 40, 42, 44 at a current position of one of the plurality of doors 36, 40, 42, 44. The initial inclination of the one of the plurality of doors 36, 40, 42, 44 at a predetermined position of one of the plurality of doors 36, 40, 42, 44 (e.g., a closed position) may be stored in the memory device 292 as a stored reading 400. The at least one power actuator 35 is operated based on a position of the one of the plurality of doors 36, 40, 42, 44 determined using the initial inclination detected at the predetermined position and the current inclination detected at the current position. In more detail, a mathematical function or look-up table 402 may also be stored in the memory device 292 to calculate the incline contribution based on initial acceleration or inclination by the inclination sensor 286 (at the closed position) and at an open position. If power is lost (e.g., power from the vehicle battery 253) or the door position is otherwise lost, the mathematical function or look-up table 402 is referenced. By using the current inclination or acceleration of the one of the plurality of doors 36, 40, 42, 44 from an unknown position and correlating the expected acceleration at a given position of the one of the plurality of doors 36, 40, 42, 44 predetermined when the one of the plurality of doors 36, 40, 42, 44 is closed (at a previously known position, for example), the current position of the one of the plurality of doors 36, 40, 42, 44 can be calculated. So, the mathematical function or look-up table 402 is used for calculating the current position of the one of the plurality of doors 36, 40, 42, 44 using the current inclination and the initial inclination detected at the predetermined position. Accordingly, the at least one controller 154, 182 is further configured to determine the current position of the one of the plurality of doors 36, 40, 42, 44 based on the current inclination and the initial inclination detected at the predetermined position using the at least one of the mathematical function or the look-up table 402. In more detail, the at least one of the mathematical function or the look-up table 402 includes a current position look-up table 402 with a plurality of predetermined values of the current position for a plurality of values of the current inclination. The at least one controller 154, 182 is further configured to determine the current position using the current inclination with the current position look-up table 402. Alternatively, the at least one of the mathematical function or the look-up table 402 includes a current position mathematical function 402 selected to calculate the current position based on the initial inclination and the current inclination. The at least one controller 154, 182 is further configured to determine the current position using the initial inclination and the current inclination with the current position mathematical function 402. Thus, while the one of a plurality of position sensors 48 may be used in conjunction with the inclination sensor 286, any absolute door position sensor, such as the one of the plurality of position sensors 48 is not required (e.g., provided at the hinge or otherwise). In other words, the at least one power actuator 35 is operated without any input from an absolute door position sensor (e.g., one of the plurality of position sensors 48). Furthermore, other expensive sensor systems for measuring absolute position measurement are unnecessary.

More specifically, according to a further aspect and referring back to FIG. 3, the power closure member actuation system 86 includes a plurality of inclination sensors 286 for each of the plurality of doors 36, 40, 42, 44. As mentioned above, the at least one controller 154, 182 includes a plurality of door control units 182 each disposed in one of the plurality of doors 36, 40, 42, 44. Each plurality of door control units 182 includes one of the plurality of inclination sensors 286. Nevertheless, as mentioned above, the power closure member actuation system 86 can also include the plurality of position sensors 48 each disposed on one of the doors 36, 40, 42, 44. Again, each of the plurality of position sensors 48 is configured to detect a position of the one of the doors 36, 40, 42, 44 associated therewith. According to an aspect of the disclosure, each one of the plurality of position sensors 48 for the one of the plurality of doors 36, 40, 42, 44 is a Hall effect sensor coupled to the at least one power actuator 35 for the one of the plurality of doors 36, 40, 42, 44.

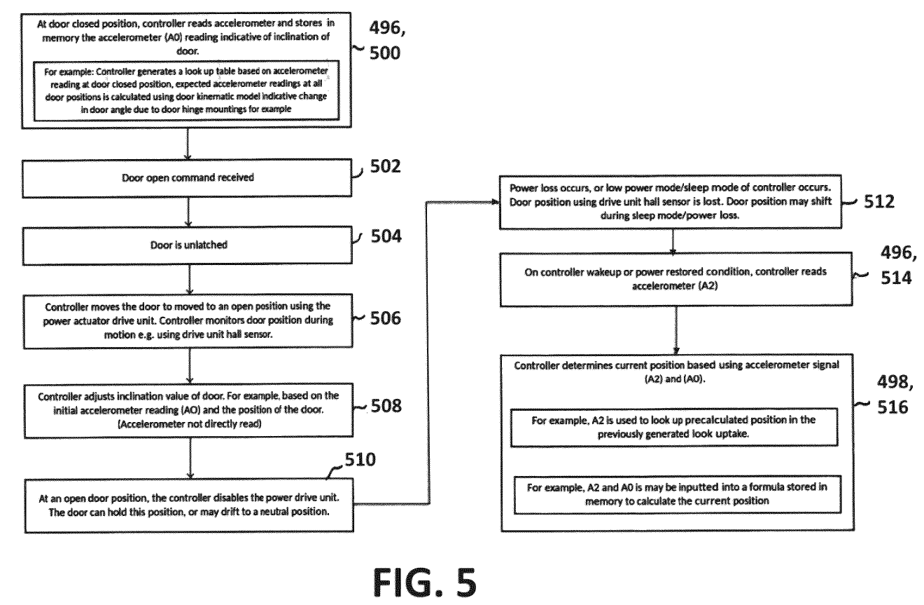

FIG. 5 illustrates steps of a method of operating the power closure member actuation system 86. As shown, the method includes the step of 496 detecting an initial inclination of one of the plurality of doors 36, 40, 42, 44 at a predetermined position of the one of the plurality of doors 36, 40, 42, 44 and a current inclination of the one of the plurality of doors 36, 40, 42, 44 at a current position of the one of the plurality of doors 36, 40, 42, 44 using an inclination sensor 286. The method also includes the step of 498 moving the one of the plurality of doors 36, 40, 42, 44 using at least one power actuator 35 associated therewith. The at least one power actuator 35 is operated based on the current position of the one of the plurality of doors 36, 40, 42, 44 determined using the initial inclination detected at the predetermined position and the current inclination detected at the current position.

As discussed above, the power closure member actuation system 86 further includes at least one controller 154, 182 comprising a plurality of door control units 182 each disposed in one of the plurality of doors 36, 40, 42, 44. The inclination sensor 286 includes a plurality of inclination sensors 286 for each of the plurality of doors 36, 40, 42, 44 and the plurality of door control units 182 each include one of the plurality of inclination sensors 286. Accordingly, the method can also include the step of detecting a position of the one of the plurality of doors 36, 40, 42, 44 using one of a plurality of position sensors 48 disposed on the one of the plurality of doors 36, 40, 42, 44 and associated therewith. Again, each one of the plurality of position sensors 48 for the one of the plurality of doors 36, 40, 42, 44 can be a Hall effect sensor coupled to the at least one power actuator 35 for the one of the plurality of doors 36, 40, 42, 44.

Continuing to refer to FIG. 5, the method includes the step of 500 reading and storing an initial inclination of the one of the plurality of doors 36, 40, 42, 44 at a closed position of one of the plurality of doors 36, 40, 42, 44 in a memory device 292 of at least one controller 154, 182. The method continues with the step of 502 receiving a door open command for the one of the plurality of doors 36, 40, 42, 44. The method proceeds by 504 unlatching a latch assembly 88, 90 of the one of the plurality of doors 36, 40, 42, 44. The next step of the method is 506 moving the one of the plurality of doors 36, 40, 42, 44 to an open position using a power actuator 35 operably coupled to the one of the plurality of doors 36, 40, 42, 44 while monitoring a position of the one of the plurality of doors 36, 40, 42, 44 during motion using one of a plurality of position sensors 48. Next, 508 determining an inclination value of the one of the plurality of doors 36, 40, 42, 44 based on the initial inclination of the one of the plurality of doors 36, 40, 42, 44 and the position of the one of the plurality of doors 36, 40, 42, 44 from the one of a plurality of position sensors 48. In addition, the method includes the step of 510 at an open position of the one of the plurality of doors 36, 40, 42, 44, disabling the power actuator 35. The method continues with the step of 512 losing the position of the one of the plurality of doors 36, 40, 42, 44 from the one of a plurality of position sensors 48. The method proceeds by 514 reading a current inclination of the one of the plurality of doors 36, 40, 42, 44 at a current position of one of the plurality of doors 36, 40, 42, 44. The method also includes the step of 516 determining the current position of the one of the plurality of doors 36, 40, 42, 44 using the initial inclination detected at the closed position and the current inclination detected at the current position.

As discussed above, the at least one controller 154, 182 can further include a memory device 292 configured to store at least one of a mathematical function or a look-up table 402 for calculating the current position of the one of the plurality of doors 36, 40, 42, 44 using the current inclination and the initial inclination detected at the predetermined position. Thus, according to an aspect, the method further includes the step of determining the current position of the one of the plurality of doors 36, 40, 42, 44 based on the current inclination and the initial inclination detected at the predetermined position using the at least one of the mathematical function or the look-up table 402. More specifically and according to further aspects, the at least one of the mathematical function or the look-up table 402 includes a current position look-up table 402 having a plurality of predetermined values of the current position for a plurality of values of the current inclination. So, the method may further include the step of determining the current position using the current inclination with the current position look-up table 402. Alternatively and according to other aspects, the at least one of the mathematical function or the look-up table 402 includes a current position mathematical function 402 selected to calculate the current position based on the initial inclination and the current inclination. Therefore, the method can further include the step of determining the current position using the initial inclination and the current inclination with the current position mathematical function 402. Once again, as discussed, any absolute door position sensor, such as the one of the plurality of position sensors 48 is not required. Accordingly, the method can further include the step of operating the at least one power actuator 35 without any input from an absolute door position sensor.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

The components of the illustrative devices, systems and methods employed in accordance with the illustrated embodiments can be implemented, at least in part, in digital electronic circuitry, analog electronic circuitry, or in computer hardware, firmware, software, or in combinations of them. These components can be implemented as a collection of instructions executed by a processing device, for example, as a computer program product such as a computer program, program code or computer instructions tangibly embodied in an information carrier, or in a machine-readable storage device, for execution by, or to control the operation of, data processing apparatus such as a programmable processor, a microprocessor, a computer, or multiple computers. The term “controller” as used in this application is comprehensive of any such computer, processor, microchip processor, integrated circuit, or any other element(s), whether singly or in multiple parts, capable of carrying programming for performing the functions, methods and flowcharts provided herein. The controller may be a single such element which is resident on a printed circuit board with the other electronic elements. It may, alternatively, reside remotely from the other elements systems described herein. For example, but without limitation, the at least one controller may take the form of programming in the onboard computer of a vehicle within the door, a latch or at other locations within the vehicle as examples. The controller may also reside in multiple locations or comprise multiple components.

A list of instructions, for example a computer program, can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Also, functional programs, codes, and code segments for accomplishing the illustrative embodiments can be easily construed as within the scope of claims exemplified by the illustrative embodiments by programmers skilled in the art to which the illustrative embodiments pertain. Method steps associated with the illustrative embodiments can be performed by one or more programmable processors executing a computer program, code or instructions to perform functions (e.g., by operating on input data and/or generating an output). Method steps can also be performed by, and apparatus of the illustrative embodiments can be implemented as, special purpose logic circuitry, e.g., an FPGA (field programmable gate array) or an ASIC (application-specific integrated circuit), for example.

The various illustrative logical blocks, modules, algorithms, steps, and circuits described in connection with the embodiments disclosed herein may be implemented or performed with a general purpose processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, microcontroller, or state machine, as examples. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, algorithms, and steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of claims exemplified by the illustrative embodiments. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. In other words, the processor and the storage medium may reside in an integrated circuit or be implemented as discrete components.

Computer-readable non-transitory media includes all types of computer readable media, including magnetic storage media, optical storage media, flash media and solid state storage media. It should be understood that software can be installed in and sold with a central processing unit (CPU) device. Alternatively, the software can be obtained and loaded into the CPU device, including obtaining the software through physical medium or distribution system, including, for example, from a server owned by the software creator or from a server not owned but used by the software creator. The software can be stored on a server for distribution over the Internet, for example.

What is claimed is:

1. A power closure member actuation system for a vehicle having a plurality of doors, comprising:
at least one power actuator associated with and configured to move one of the plurality of doors; and
an inclination sensor configured to detect an initial inclination of the one of the plurality of doors at a predetermined position of one of the plurality of doors and a current inclination of the one of the plurality of doors at a current position of one of the plurality of doors, wherein the at least one power actuator is operated based on the current position of the one of the plurality of doors determined using the initial inclination detected at the predetermined position and the current inclination detected at the current position.

2. The power closure member actuation system as set forth in claim 1, further including at least one controller comprising a plurality of door control units each disposed in one of the plurality of doors and wherein the inclination sensor includes a plurality of inclination sensors for each of the plurality of doors and the plurality of door control units each include one of the plurality of inclination sensors.

3. The power closure member actuation system as set forth in claim 2, further including a plurality of position sensors each disposed on one of the plurality of doors and configured to detect a position of the one of the plurality of doors associated therewith.

4. The power closure member actuation system as set forth in claim 3, wherein the each one of the plurality of position sensors for the one of the plurality of doors is a Hall effect sensor coupled to the at least one power actuator for the one of the plurality of doors.

5. The power closure member actuation system as set forth in claim 3, further including a latch assembly in communication with the at least one controller and associated with and configured to latch and unlatch each of the plurality of doors and wherein the at least one controller includes a memory device and is further configured to:
read and store the initial inclination of the one of the plurality of doors at a closed position of the one of the plurality of doors in the memory device of the at least one controller;
receive a door open command for the one of the plurality of doors;
unlatch the latch assembly of the one of the plurality of doors;
move the one of the plurality of doors to an open position using the at least one power actuator operably coupled to the one of the plurality of doors while monitoring a position of the one of the plurality of doors during motion using one of the plurality of position sensors;
determine an inclination value of the one of the plurality of doors based on the initial inclination of the one of the plurality of doors and the position of the one of the plurality of doors from the one of a plurality of position sensors; and
at an open position of the one of the plurality of doors, disable the power actuator.

6. The power closure member actuation system as set forth in claim 5, wherein the at least one controller is further configured to:
lose the position of the one of the plurality of doors from the one of a plurality of position sensors;
read a current inclination of the one of the plurality of doors at a current position of one of the plurality of doors; and
determine the current position of the one of the plurality of doors using the initial inclination detected at the closed position and the current inclination detected at the current position.

7. The power closure member actuation system as set forth in claim 2, wherein the at least one controller further includes a memory device configured to store at least one of a mathematical function or a look-up table for calculating the current position of the one of the plurality of doors using the current inclination and the initial inclination detected at the predetermined position and the at least one controller is further configured to determine the current position of the one of the plurality of doors based on the current inclination and the initial inclination detected at the predetermined position using the at least one of the mathematical function or the look-up table.

8. The power closure member actuation system as set forth in claim 7, wherein the at least one of the mathematical function or the look-up table includes a current position look-up table having a plurality of predetermined values of the current position for a plurality of values of the current inclination and the at least one controller is further configured to determine the current position using the current inclination with the current position look-up table.

9. The power closure member actuation system as set forth in claim 7, wherein the at least one of the mathematical function or the look-up table includes a current position mathematical function selected to calculate the current position based on the initial inclination and the current inclination and the at least one controller is further configured to determine the current position using the initial inclination and the current inclination with the current position mathematical function.

10. The power closure member actuation system as set forth in claim 1, wherein the at least one power actuator is operated without any input from an absolute door position sensor.

11. A method of operating power closure member actuation system for a vehicle having a plurality of doors, comprising the steps of:
detecting an initial inclination of one of the plurality of doors at a predetermined position of the one of the plurality of doors and a current inclination of the one of the plurality of doors at a current position of the one of the plurality of doors using an inclination sensor; and
moving the one of the plurality of doors using at least one power actuator associated therewith, the at least one power actuator operated based on the current position of the one of the plurality of doors determined using the initial inclination detected at the predetermined position and the current inclination detected at the current position.

12. The method as set forth in claim 11, wherein the power closure member actuation system further includes at least one controller comprising a plurality of door control units each disposed in one of the plurality of doors and the inclination sensor includes a plurality of inclination sensors for each of the plurality of doors and the plurality of door control units each include one of the plurality of inclination sensors.

13. The method as set forth in claim 12, further including the step of detecting a position of the one of the plurality of doors using one of a plurality of position sensors disposed on the one of the plurality of doors and associated therewith.

14. The method as set forth in claim 13, wherein the each one of the plurality of position sensors for the one of the plurality of doors is a Hall effect sensor coupled to the at least one power actuator for the one of the plurality of doors.

15. The method as set forth in claim 13, further including the steps of:
reading and storing the initial inclination of the one of the plurality of doors at a closed position of the one of the plurality of doors in a memory device of at least one controller;
receiving a door open command for the one of the plurality of doors;
unlatching a latch assembly of the one of the plurality of doors;
moving the one of the plurality of doors to an open position using the at least one power actuator operably coupled to the one of the plurality of doors while monitoring a position of the one of the plurality of doors during motion using one of the plurality of position sensors;
determining an inclination value of the one of the plurality of doors based on the initial inclination of the one of the plurality of doors and the position of the one of the plurality of doors from the one of a plurality of position sensors; and
at an open position of the one of the plurality of doors, disabling the power actuator.

16. The method as set forth in claim 15, further including the steps of:
losing the position of the one of the plurality of doors from the one of a plurality of position sensors;
reading a current inclination of the one of the plurality of doors at a current position of one of the plurality of doors; and
determining the current position of the one of the plurality of doors using the initial inclination detected at the closed position and the current inclination detected at the current position.

17. The method as set forth in claim 12, wherein the at least one controller further includes a memory device configured to store at least one of a mathematical function or a look-up table for calculating the current position of the one of the plurality of doors using the current inclination and the initial inclination detected at the predetermined position and the method further includes the step of determining the current position of the one of the plurality of doors based on the current inclination and the initial inclination detected at the predetermined position using the at least one of the mathematical function or the look-up table.

18. The method as set forth in claim 17, wherein the at least one of the mathematical function or the look-up table includes a current position look-up table having a plurality of predetermined values of the current position for a plurality of values of the current inclination and the method further includes the step of determining the current position using the current inclination with the current position look-up table.

19. The method as set forth in claim 11, further including the step of operating the at least one power actuator without any input from an absolute door position sensor.

20. A power closure member actuation system for a vehicle having a door moveable between and open position and a closed position, comprising:
a power actuator associated with and configured to move the door using a position value of the door; and
an inclination sensor configured to detect an inclination of the door;
wherein the position value is updated using the inclination sensor following a loss in tracking of the door position of the power closure member actuation system of the power closure member actuation system.
